(19) United States
(12) Patent Application Publication
(10) Pub. No.: US 2014/0104273 A1
(43) Pub. Date: Apr. 17, 2014

(54) INTERACTIVE EXTRACTION OF NEURAL STRUCTURES WITH USER-GUIDED MORPHOLOGICAL DIFFUSION

(71) Applicant: UNIVERSITY OF UTAH RESEARCH FOUNDATION, Salt Lake City, UT (US)

(72) Inventors: Hideo Otsuna, Salt Lake City, UT (US); Yong Wan, Salt Lake City, UT (US); Charles D. Hansen, Salt Lake City, UT (US); Chi-Bin Chien, Salt Lake City, UT (US)

(73) Assignee: UNIVERSITY OF UTAH RESEARCH FOUNDATION, Salt Lake City, UT (US)

(21) Appl. No.: 14/051,947

(22) Filed: Oct. 11, 2013

Related U.S. Application Data
(60) Provisional application No. 61/713,002, filed on Oct. 12, 2012.

(51) Int. Cl. G06T 7/00

(52) U.S. Cl. CPC G06T 7/0091
USPC 345/423

(57) ABSTRACT

A method of identifying a structure in a volume of data. The method includes steps of generating a scalar mask volume which corresponds to at least a portion of the volume of data; displaying the volume of data to a user through a viewport; obtaining from a user at least one seed region identified on the viewport; projecting the seed region from the viewport into the scalar mask volume to identify at least one segmentation seed within the scalar mask volume; obtaining from a user at least one diffusion region identified on the viewport; projecting the diffusion region from the viewport into the scalar mask volume to identify a region for seed growth within the scalar mask volume; and growing the at least one segmentation seed within the scalar mask volume to identify a structure within the volume of data.

### CROSS-REFERENCE TO RELATED APPLICATIONS

This application claims priority to U.S. Provisional Patent Application No. 61/713,002 filed Oct. 12, 2012, the content of which is incorporated herein by reference in its entirety.

### FEDERALLY-SPONSORED RESEARCH

This invention was made with government support under ROl MH092256-01 and RO1 GM098151-01 awarded by National Institutes of Health. The government has certain rights in the invention.

### BACKGROUND

The present invention relates to segmentation of three-dimensional data in real time.

Extracting neural structures with their fine details from confocal volumes is essential to quantitative analysis in neurobiology research. Despite the abundance of various segmentation methods and tools, for complex neural structures, both manual and semi-automatic methods are ineffective either in full three-dimensional (3D) views or when user interactions are restricted to two-dimensional (2D) slices. Novel interaction techniques and fast algorithms are demanded by scientists (particularly neurobiologists) to interactively and intuitively extract structures (e.g. neural structures) from 3D data (e.g. confocal microscope data).

### SUMMARY

Presented herein is an algorithm-technique combination that lets users interactively select desired structures from visualization results in a 3D volume instead of 2D slices. By integrating the segmentation functions with a confocal visualization tool, researchers such as neurobiologists can easily extract complex structures (e.g. neural structures) within their typical visualization workflow.

In one embodiment, the invention provides a method of identifying a structure in a volume of data. The method includes steps of generating a scalar mask volume which corresponds to at least a portion of the volume of data; displaying the volume of data to a user through a viewport; obtaining from a user at least one seed region identified on the viewport; projecting the seed region from the viewport into the scalar mask volume to identify at least one segmentation seed within the scalar mask volume; obtaining from a user at least one diffusion region identified on the viewport; projecting the diffusion region from the viewport into the scalar mask volume to identify a region for seed growth within the scalar mask volume; and growing the at least one segmentation seed within the scalar mask volume to identify a structure within the volume of data.

In another embodiment, the invention provides a computer-based system for identifying a structure in a volume of data. The system includes a processor and a storage medium. The storage medium is operably coupled to the processor, wherein the storage medium includes, program instructions executable by the processor for generating a scalar mask volume which corresponds to at least a portion of the volume of data; displaying the volume of data to a user through a viewport; obtaining from a user at least one seed region identified on the viewport; projecting the seed region from the viewport into the scalar mask volume to identify at least one segmentation seed within the scalar mask volume; obtaining from a user at least one diffusion region identified on the viewport; projecting the diffusion region from the viewport into the scalar mask volume to identify a region for seed growth within the scalar mask volume; and growing the at least one segmentation seed within the scalar mask volume to identify a structure within the volume of data.

In yet another embodiment, the invention provides a computer-readable medium. The computer-readable medium includes first instructions executable on a computational device for generating a scalar mask volume which corresponds to at least a portion of the volume of data; second instructions executable on the computational device for displaying the volume of data to a user through a viewport; third instructions executable on the computational device for obtaining from a user at least one seed region identified on the viewport; fourth instructions executable on the computational device for projecting the seed region from the viewport into the scalar mask volume to identify at least one segmentation seed within the scalar mask volume; fifth instructions executable on the computational device for obtaining from a user at least one diffusion region identified on the viewport; sixth instructions executable on the computational device for projecting the diffusion region from the viewport into the scalar mask volume to identify a region for seed growth within the scalar mask volume; and seventh instructions executable on the computational device for growing the at least one segmentation seed within the scalar mask volume to identify a structure within the volume of data.

Other aspects of the invention will become apparent by consideration of the detailed description and accompanying drawings.

### BRIEF DESCRIPTION OF THE DRAWINGS

FIG. 1 shows a user interface for segmentation in a known image processing system in which a user must perform segmentation on a slice-by-slice basis for 3D objects.

FIGS. 2A-2D show conserving and non-conserving energy transmissions. FIG. 2A shows that the initial state has a linear gradient, where the energy change of the center piece is of interest. FIG. 2B shows that energy is transferred from high to low (gradient direction), as indicated by the arrows. FIG. 2C shows a result of typical conserving transmission, where the center piece receives and gives the same amount of energy, which maintains a solenoidal gradient field. FIG. 2D shows a result of dilation-like transmission, which is not energy conserving; the center piece gains energy and a solenoidal gradient field cannot be sustained.

FIGS. 3A-3D show volume paint selection of neural structures from a confocal volume. FIG. 3A shows the visualization of certain neural structures (top) and the camera setup (bottom). FIG. 3B shows as a user paints on the viewport, where the stroke (green) is projected back into the volume to define the seed generation region. FIG. 3C shows as the user paints on the viewport to define the diffusion region, where the stroke (red) is projected similarly and the seeds generated in FIG. 3B grow to either the structural boundaries or the boundary defined by the red stroke. FIG. 3D shows the intended neural structure that is extracted.

FIG. 4 shows the two parts of the stopping function, where gᵢ( )(left panel) is for stopping the growth at high gradient magnitude values and g₂( )(right panel) is for stopping at low scalar intensities and the final stopping function is the product of g₁( )and g₂O.

FIGS. 5A-5D show a selection brush, where the dataset contains neurons of a Drosophila adult brain. FIG. 5A shows the original dataset which has a neuron that a user wants to extract, which is visual projection neuron LC14 [16]. FIG. 5B shows a stroke that is painted with the selection brush. FIG. 5C shows a second stroke that is painted, which covers the remaining part of the neuron. FIG. 5D shows the neuron that is extracted.

FIGS. 6A-6H show an eraser function, where the dataset contains neurons of a Drosophila adult brain. FIG. 6A shows a yellow dotted region which indicates the structure that a user wants to extract (visual projection neuron LT1 [16]); from the observing direction, the structure obstructs another neuron behind (visual projection neuron VS [16]). FIG. 6B shows a stroke that is painted with the selection brush. FIG. 6C shows that LT1 is extracted, but that VS is partially selected as well. FIG. 6D shows the view after it is rotated around the lateral axis, where the yellow dotted region indicates extra structures to be removed. FIG. 6E shows a stroke that is painted with the eraser. FIG. 6F shows the extra structures that are removed (deselected). FIG. 6G shows the view after it is rotated back. FIG. 6H shows a visualization of the extracted neuron (LT1).

FIGS. 7A-7F show a diffusion brush, where the dataset contains neurons of a Drosophila adult brain. FIG. 7A shows the original dataset, which is the same dataset as in FIG. 6. FIG. 7B shows a stroke that is painted with the selection brush on the non-obstructing part of LT1. FIG. 7C shows that part of LT1 is selected, after which the diffusion brush is used to select the remaining portion of LT1. FIG. 7D shows that LT1 is selected, without selecting the obstructed neuron (visual projection neuron VS). FIG. 7E shows the view after it is rotated around the lateral axis, to confirm the result. FIG. 7F shows a visualization of neuron LT1 after extraction.

FIGS. 8A-8D show a digital tablet and its usage, where the dataset contains neurons of a zebrafish head. FIG. 8A shows the original dataset, which contains stained tectum lobes and photoreceptors of eyes; since the tectum lobes and the photoreceptors actually connect, it is important to have better control of the brush size for diffusion at the regions of connection, when only the tectum lobes are to be extracted. FIG. 8B shows the two strokes that are painted with the selection brush where the stroke size changes as the user varies the pressure applied to the tablet's stylus. FIG. 8C shows that the tectum lobes are selected. FIG. 8D shows the tectum lobes that are extracted and visualized.

FIGS. 9A-9E show the influence of the stopping function parameters on segmentation results, where the user wants to extract the eye muscle motor neurons from a zebrafish head dataset. The left column shows the selected results; the right column shows the extracted results. FIG. 9A shows that default values give satisfactory results: completely selected fiber without much noise. FIG. 9B shows that shifting the scalar falloff higher, to 0.2, can barely select any fiber at its faintly stained regions. FIG. 9C shows that decreasing the scalar falloff includes more noise in the selection. FIG. 9D shows that increasing the gradient magnitude falloff includes more details, however further increasing the value does not make much difference, since higher gradient magnitude values become scarce in the data. FIG. 9E shows that decreasing the gradient magnitude falloff results in disconnected fibers.

FIGS. 10A-10C show a comparison between standard anisotropic diffusion (FIG. 10B) and morphological diffusion (FIG. 10C), where a user wants to extract the eye muscle motor neurons from a zebrafish head dataset (FIG. 10A). The same selection brush stroke from the viewing angle of the raw data (FIG. 10A) is applied for both methods (FIGS. 10B, 10C). However, morphological diffusion (FIG. 10C) can extract the result with fewer iterations and less time than anisotropic diffusion (FIG. 10B). All arrowheads point to regions where details are better extracted with our method. The magenta arrowhead in each panel (top) indicates part of the eye motor neuron being extracted, which was originally occluded behind the tectum. Timings are measured on a PC with an Intel i7 975 3.33GHz processor, 12 GB memory, an AMD Radeon HD4870 graphics card with 1 GB graphics memory, and Microsoft Windows 7 64-bit.

FIGS. 11A-11B show an analysis of data from zebrafish. FIG. 11A shows a zebrafish dataset originally has two channels: neurons (green) and nuclei (magenta). FIG. 11B shows that, after extracting three different structures (the tectum, the eye motor neuron and the eye are on the same side of the head) from the neuron channel, the spatial relationships are clearly visualized with different colors applied.

FIG. 12 shows a computer system for implementation of embodiments of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

Disclosed herein is a novel segmentation method that is able to interactively extract neural structures from three-dimensional data such as confocal microscopy data. It uses morphological diffusion for region-growing, which can generate stable results for confocal data in real-time. Its interaction scheme explores the visualization capabilities of an existing confocal visualization system, FluoRender [31], and lets users paint directly on volume rendering results and select desired structures.

Although the examples referred to herein are focused on fluorescently-labeled neural structures imaged using confocal microscopy, the disclosed techniques can be used for extracting structures from other kinds of data, including meteorologic volume rendering, astronomical volume rendering, 3D geological volume rendering, and medical images (e.g. CT/MRI).

In neurobiology research in particular, data analysis typically focuses on extraction and comparison of geometric and topological properties of neural structures acquired from microscopy. In recent years, laser scanning confocal microscopy has gained substantial popularity because of its capability of capturing fine-detailed structures in 3D. With laser scanning confocal microscopy, neural structures of biological samples are tagged with fluorescent staining and scanned with laser excitation. Although there are some tools available for generating clear visualizations and facilitating qualitative analysis of confocal microscopy data, quantitative analysis requires extracting important features. For example, a user may want to extract just one of two adjacent neurons and analyze its structure. In such case, segmentation requires the user's guidance in order to correctly separate the desired structure from the background. There exist many interactive segmentation tools that allow users to select seeds (or draw boundaries) within one slice of volumetric data. Either the selected seeds grow (or the boundaries evolve) in 2D and then the user repeats the operation for all slices, or the seeds grow (or the boundaries evolve) three-dimensionally. Interactive segmentation with interactions on 2D slices may be sufficient for some structures with relatively simple shapes, such as internal organs or a single, isolated nerve fiber. However, for most neural structures from confocal microscopy, the high complexity of their shapes and intricacy between adjacent structures make identifying desired structures from even 2D slices difficult.

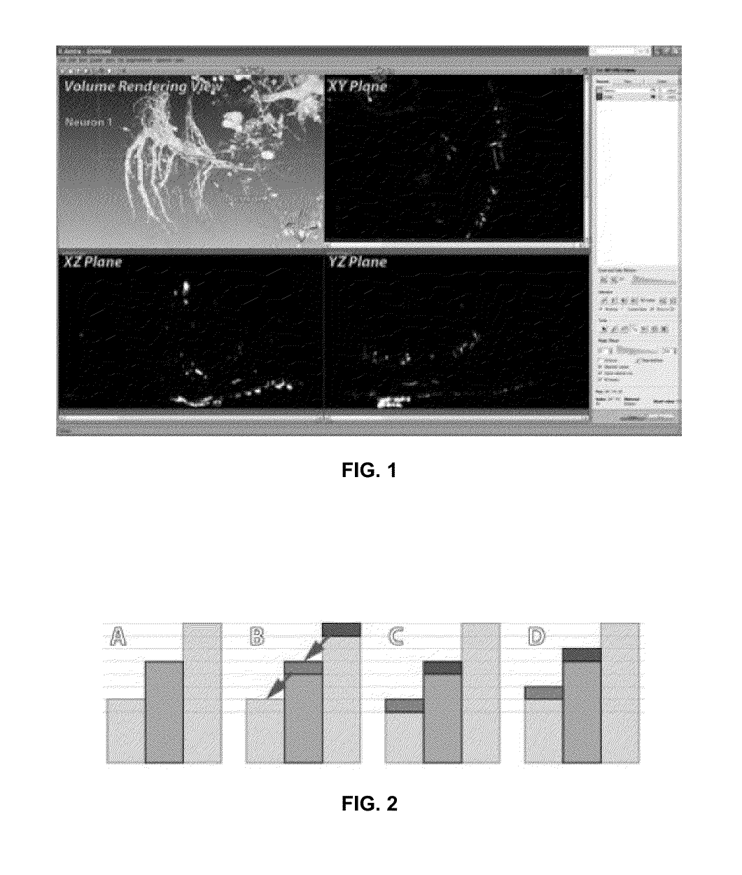

FIG. 1 shows the user interface of the system of Amira [30], which is commonly used in neurobiology for data processing. Neurons of a Drosophila adult brain are loaded. From its interactive volume rendering view, two neurons are in proximity to one another and have complex details, whereas the fine structures of branching axons are merely distinct blobs in the 2D slice views. Thus it is difficult to tell the two neurons apart from one another or to infer their shapes from any of the slice views. This makes 2D-slice-based interactions of most volume segmentation tools in neurobiology ineffective. It can be difficult under these circumstances to choose proper seeds or draw boundaries on slices. Unfortunately, users have to select structures from the individual slice views rather than from the volume rendering view, where they can actually see the data more clearly. Many interactive volume segmentation tools in neurobiology use similar interactions, which are difficult to use for complex shapes. Even if seeds are chosen and their growth in 3D is automated, it is difficult for unguided 3D growth schemes to avoid over- or under-segmentations, especially for detailed and complex structures such as axon terminals. Lastly, there is no interactive method to quickly identify and correct the segmented results at problematic regions. With well-designed visualization tools, neurobiologists are able to observe the complex neural structures and inspect them from different view directions. Segmentation interactions which are designed based on volume visualization tools and which let users select from what they see are apparently the most intuitive. In practice, confocal laser scanning can generate datasets with high throughput, and neurobiologists often conduct experiments and scan multiple mutant samples in batches. Thus, a segmentation algorithm for neural structure extraction from confocal data also needs to make good use of the parallel computing power of contemporary PC hardware and generate a stable segmented result with real-time speed.

Current segmentation methods for volumetric data are generally categorized into two kinds full manual and semiautomatic. While the concept of fully automatic segmentation exists, the implementations of this concept have drawbacks including being limited to ideal and simple structures, requiring complex parameter adjustment, or require extensive system ‘training’ using a vast amount of manually segmented results. In addition, current fully automatic segmentation systems fail in the presence of noisy data, such as confocal scans. Thus, robust fully automatic segmentation methods do not exist in practice, especially in cases described above in which complex and intricate structures are extracted according to users' research needs.

In biology research, fully manual segmentation is still the most commonly used method. Though actual tools vary, they all allow manual selection of structures from each slice of volumetric data. For example, the system of Amira [30] is often used for extracting structures from confocal data. With complex structures, such as neurons in confocal microscopy data, it requires great familiarity with the data and the capability of inferring 3D shapes from slices. For the same confocal dataset shown in FIG. 1, it took a trained neurobiologist a full week to manually select a single neuron from the dataset, since it was difficult to separate the details of the two neurons that were in close proximity to each other. However, such intense work would not guarantee a satisfactory result, as some fine fibers of low scalar intensities might be missing. Even when the missing parts could be visualized with a volume rendering tool, it was still difficult to go back and track the problems within the slices. To improve the efficiency of manual segmentations, biologists have tried different methods. For example, VolumeViewer from Sowell et al. [26] allows users to draw contours on oblique slicing planes, which helps surface construction for simple shapes but is still not effective for complex structures. Using the volume intersection technique from Martin and Aggarwal [13] or Space Carving from Kutulakos and Seitz [10], Tay et al. [27] drew masks from two orthographic MIP renderings and projected them into 3D to carve a neuron out from their confocal data. However, the extracted neuron in their research had a very simple shape.

For extracting complex 3D structures, semi-automatic methods, which combine specific segmentation algorithms with user guidance, appears to be a more promising approach than fully manual segmentation. However, choosing an appropriate combination of algorithm and user interaction for a specific segmentation problem, such as neural structure extraction from confocal data, remains an active research topic. Many segmentation algorithms for extracting irregular shapes consist of two major calculations, i.e. noise removal and boundary detection. Most filters designed for 2D image segmentation can be easily applied to volumetric data. Possible filters include all varieties of low-pass filters, bilateral filters, and rank filters (including median filter, as well as dilation and erosion from mathematical morphology) [6]. Boundaries within the processed results are very commonly extracted by calculations on their scalar values, gradient magnitudes, and sometimes curvatures.

Most segmentation research has focused on improving accuracy and robustness, but little has been done from the perspective of user interactions, especially in real-world applications. Sketch-based interaction methods, which let users directly paint on volume rendering results and select desired structures, have demonstrated the potential towards more intuitive semi-automatic volume segmentation schemes. Here is demonstrate implementation of a sketch-based volume selection method, focusing on combining segmentation algorithms and interactive techniques, as well as the development of an interactive tool for intuitive extraction of neural structures from confocal data.

Mathematical Background of Morphological Diffusion

For interactive speed of confocal volume segmentation, morphological diffusion on a mask volume is used for selecting desired neural structures. Morphological diffusion can be derived as one type of anisotropic diffusion under the assumption that energy can be non-conserving during transmission. Its derivation uses the results from both anisotropic diffusion and mathematical morphology.

Diffusion Equation and Anisotropic Diffusion

The diffusion equation describes energy or mass distribution in a physical process exhibiting diffusive behavior. For example, the distribution of heat (u) in a given isotropic region over time (t) is described by the heat equation:

$$\frac{\partial u ( x , t )}{\partial t} = c {∇}^{2} u ( x , t ) = ∇ \cdot ( c ∇ u ( x , t ) ) \qquad ( 1 )$$

In Equation 1, c is a constant factor describing how fast temperature can change within the region. We want to establish a relationship between heat diffusion and morphological dilation. First we look at the conditions for a heat diffusion process to reach its equilibrium state. Equation 1 simply tells us that the change of temperature equals the divergence of the temperature gradient field, modulated by a factor c. We can then classify the conditions for the equilibrium state into two cases:

Zero gradient. Temperatures are the same everywhere in the region.

Solenoidal (divergence-free) gradient. The temperature gradient is non-zero, but satisfies the divergence theorem for an incompressible field, i.e. for any closed surface within the region, the total heat transfer (net heat flux) through the surface must be zero.

The non-zero gradient field can be sustained because of the law of conservation of energy. Consider the simple 1D case in FIG. 2, where the temperature is linearly increasing over the horizontal axis. For any given point, it gives heat out to its left neighbor with lower temperature and simultaneously receives heat of the same amount from its right neighbor. In this one-dimensional (1D) case, the loss and gain of heat reach a balance when the temperature field is linear. As discussed below, if we lift the restriction of energy conservation, the condition for equilibrium may not hold, and we need to rewrite the heat equation under new propositions.

The generalized diffusion equation is anisotropic. Specifically, we are interested in the anisotropic diffusion equation proposed by Perona and Malik [19], which has been extensively studied in image processing.

$$\frac{\partial u ( x , t )}{\partial t} = ∇ \cdot ( g ( x , t ) ∇ u ( x , t ) ) \qquad ( 2 )$$

In Equation 2, the constant c in the heat equation is replaced by a function g(), which is commonly calculated in order to stop diffusion at high gradient magnitude of u.

Morphological Operators and Morphological Gradients

In mathematical morphology, erosion and dilation are the fundamental morphological operators. The erosion of an image I by a structuring element B is:

ε(x)=min(I(x+b)|b εB) (3)

And the dilation of an image I by a structuring element B is:

δ(x)=max(I(x+b)|b ΕB) (4)

For a flat structuring element B, they are equivalent to filtering the image with minimum and maximum filters (rank filters of rank 1 and N, where Nis the total number of pixels in B), respectively.

In differential morphology, erosion and dilation are used to define morphological gradients, including Beucher gradient, internal and external gradients, etc. Detailed discussions can be found in [20] and [25]. As disclosed herein, we are interested in the external gradient with a flat structuring element, since for confocal data we always want to extract structures with high scalar values and the region-growing process of high scalar values resembles dilation. Thus the morphological gradient used in this paper is:

|∇I(x)|=δ(x) −I(x) (5)

Please note that for a multi-variable function I, Equation 5 is essentially a discretization scheme for calculating the gradient magnitude of I at position x.

Morphological Diffusion

If we consider the morphological dilation defined in Equation 4 as energy transmission, it is interesting to notice that energy is not conserved. In FIG. 2, we show that within a neighborhood of a given position, the local maximum can give out energy without losing its own. Thus, for a closed surface within the whole region, the net energy flux can be non-negative. In other words, under the above assumption of non-conserving energy transmission, the solenoidal gradient condition for the equilibrium of heat diffusion no longer holds. Therefore, the heat diffusion can only reach its equilibrium when the energy field has zero gradient.

Based on the above reasoning, we can rewrite the heat equation (Equation 1) to its form under the dilation-like energy transmission:

$$\frac{\partial u ( x , t )}{\partial t} = c \vert ∇ u ( x , t ) \vert \qquad ( 6 )$$

Equation 6 can be simply derived from Fourier's law of heat conduction [4], which states that heat flux is proportional to negative temperature gradient. However we feel our derivation can better reveal the relationship between heat diffusion and morphological dilation. To solve this equation, we use forward Euler through time and the morphological gradient in Equation 5. Notice that the time step At can be specified with c for simplicity when the discretization of time is uniform. Then the discretization of Equation 6 becomes:

$$\begin{matrix}{u}_{i + 1} ( x ) = {u}_{i } ( x ) + c ( {δ}_{i } ( x ) - {u}_{i} ( x ) ) \\ = c {δ}_{i } ( x ) + ( 1 - c ) {u}_{i} ( x )\end{matrix} \qquad ( 7 )$$

When c=1, the trivial solution of Equation 6 becomes the successive dilation of the initial heat field, which is exactly what we expected.

Thus, we have established the relationship between morphological dilation and heat diffusion from the perspective of energy transmission. We name Equation 7 morphological diffusion, which can be seen as one type of heat diffusion process under non-conserving energy transmission. Though a similar term has been used in the work of Segall and Acton [23], we use morphological operators for the actual diffusion process rather than calculating the stopping function of anisotropic diffusion. Our purpose of using the result for interactive volume segmentation rather than simulating physical processes legitimizes the lifting of the requirement for conservation. We are interested in the anisotropic version of Equation 7, which is obtained simply by replacing the constant c with a stopping function g(x):

$$\begin{matrix}{u}_{i + 1} ( x ) = {u}_{i } ( x ) + g ( x ) ( {δ}_{i} ( x ) - {u}_{i} ( x ) ) \\ = g ( x ) {δ}_{i} ( x ) + ( 1 - g ( x ) ) {u}_{i} ( x )\end{matrix} \qquad ( 8 )$$

In Equation 8, when the stopping function g(x) is in [0; 1], the iterative results are bounded and monotonically increasing, which leads to a stable solution. By using morphological dilation (i.e. maximum filtering), morphological diffusion has several advantages when applied to confocal data and implemented with graphics hardware. Morphological dilation's kernel is composed of only comparisons and has the least computational overhead. The diffusion process only evaluates at non-local maxima, which are forced to reach their stable states with fewer iterations. This unilateral influence (vs. bilateral of a typical anisotropic diffusion) of high intensity signals upon lower ones may not be desired for all situations. However, for confocal fluorescent microscopy data, whose signal results from fluorescent staining and laser excitation, high intensity signals usually represent important structures, which can then be extracted with a faster speed. As shown below, when coupled with user interactions, morphological diffusion is able to extract desired neural structures from typical confocal data with interactive speed on common PCs.

User Interactions for Interactive Volume Segmentation

Paint selection [14], [12] with brush strokes is considered one of the most useful methods for 2D digital content authoring and editing. Incorporated with segmentation techniques, such as level set and anisotropic diffusion, it becomes more powerful, yet still intuitive, to use. For most volumetric data, this method becomes difficult to use directly on the renderings, due to occlusion and the complexity of determining the depth of the selection strokes. Therefore many volume segmentation tools' user interactions are limited to 2D slices. Taking advantage of the fact that the confocal channels usually have sparsely distributed structures, direct paint selection on the render viewport is actually very feasible, though selection mistakes caused by occlusion cannot be completely avoided. Using the results discussed above, we developed interaction techniques that generate accurate segmentations of neural structures from confocal data. The algorithm presented above allows us to use paint strokes with varying sizes, instead of thin strokes as in previous work. We design the paint strokes specifically for any type of volume data and emphasize accuracy for the volume extraction.

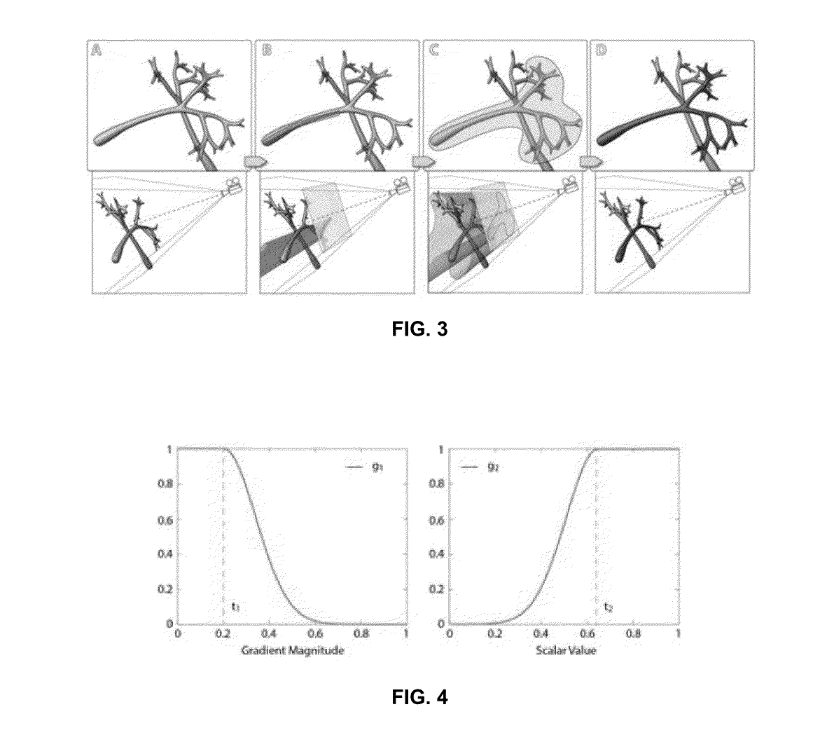

FIGS. 3A-3D illustrate an embodiment of the basic process of extracting a neural structure from a confocal volume using the methods disclosed herein. The top panels show a view corresponding to the user's viewport and the lower panels show a side view which depicts the process of projection from the viewport into the dataset. First, a scalar mask volume is generated (FIG. 3A). Then the user defines seed regions by painting on the render viewport (FIG. 3B). The pixels of the defined region are then projected into 3D as a set of cones (cylinders if the viewport is orthographic) from the camera's viewpoint (FIG. 3B). Voxels within the union of these cones are thresholded to generate seeds in the mask volume, where seeds have the maximum scalar value and other voxels have zero value. Then a wider region, which delimits the extent of subsequent diffusion, is defined by painting again on the viewport (FIG. 3C). The second region is projected into the volume using a similar procedure. Then in the mask volume, the selected seeds are propagated by iteratively evaluating Equation 8. Structures connected to those registered by the seeds are then selected in the mask volume (FIG. 3D). The resulting mask volume is not binary, though the structural boundaries can be more definitive by adjusting the stopping function, which is discussed below. After each stroke, the mask volume is instantly applied to the original volume, and the selected structures are visualized with a different color against the original data. The user can repeat this process for complex structures, since the calculation only modifies the mask volume and leaves the original data intact.

We use gradient magnitude (|ΔV|) as well as scalar value (V) of the original volume to calculate the stopping function in Equation 8, since, for confocal data, important structures are stained by fluorescent dyes and are expected to have high scalar values:

$$g ( V ) = {g}_{1} ( V ) \cdot {g}_{2} ( V ) \\ {g}_{1} ( V ) = \{ \begin{matrix}1 & \vert ∇ V \vert < {t}_{1} \\ {e}^{- \frac{{( \vert ∇ V \vert - {t}_{1} )}^{2}}{{k}_{1}^{2}}} & otherwise\end{matrix} \\ {g}_{2} ( V ) = \{ \begin{matrix}{e}^{- \frac{{( V - {t}_{2} )}^{2}}{{k}_{2}^{2}}} & V < {t}_{2} \\ 1 & otherwise\end{matrix} \qquad ( 9 )$$

The graphs of the two parts of the stopping function are in FIG. 4. t₁ and t₂ translate, or shift, the falloffs of g₁( )and g₂( ) and the falloff steepness is controlled by k₁ and k₂. The combined effect of g₁( )and g₂( )is that the seed growing stops at one or both of high gradient magnitude values and low intensities, which are considered borders for neural structures in confocal data, although other criteria may be used for other types of data.

By limiting the seed growth region with brush strokes, users have the flexibility of selecting the desired structure from the most convenient angle of view. Furthermore, it also limits the region for diffusion calculations which helps ensure real-time interactions. For less complex neural structures, seed generation and growth region definition can be combined into one brush stroke; for over-segmented or mistakenly-selected structures, an eraser can subtract the unwanted parts. In various embodiments, three brush types can be used for both simplicity and flexibility of segmentation. Scientists such as neurobiologists, as well as other users, can use these brushes to extract different structures (e.g. neural structures) from confocal data or other data sets. Depending on the type of pointing device that is used,

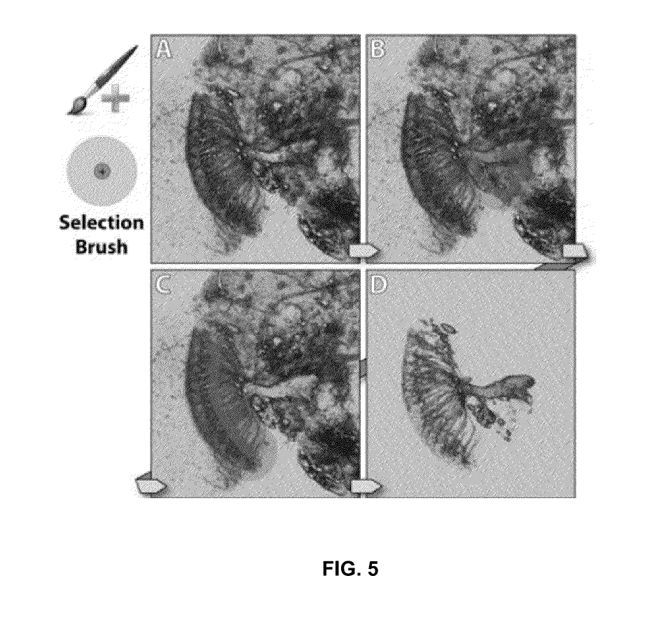

The selection brush combines the definition of seed and diffusion regions in one operation. As shown in FIG. 5, the selection brush includes two concentric circles in the brush stamp shape. Strokes created by the inside circle are used for seed generation, and those created by the outside circle are for diffusion region definition. Usually the diameter of the inside circle is set slightly smaller than the root of a structure. The diameter of the outside circle is determined by how the sub-structures branch out from the root structure. Combining the two operations into one makes interaction easier. For example, to extract an axon and its terminal branches, the inside circle is set roughly to the size of the axon, and the outside circle is set to that can enclose the terminals. Morphological diffusion is calculated on finishing each stroke, which appends newly selected structures to existing selections. Since users can easily rotate the view while painting, it is helpful to use this tool and select multiple structures or different parts of one complex structure from the most convenient observing directions. FIG. 5 demonstrates using the selection brush to extract a visual projection neuron of a Drosophila brain.

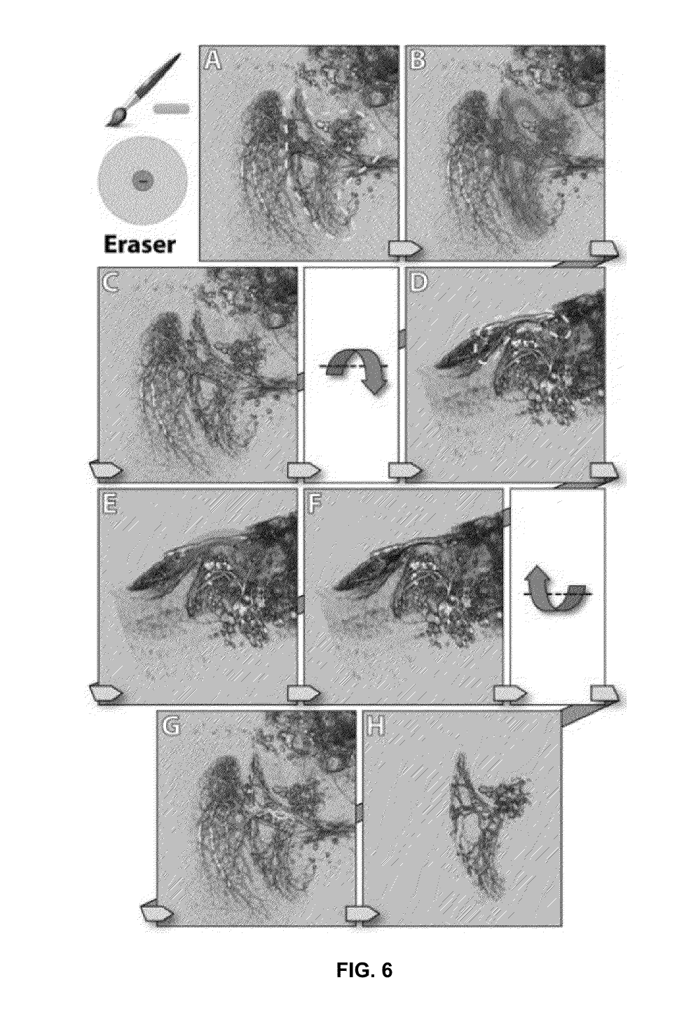

The eraser behaves similarly to the selection brush, except that it first uses morphological diffusion to select structures, and then subtracts the selection from previous results. The eraser is an intuitive solution to issues caused by occluding structures: mistakenly selected structures because of obstruction in 2D renderings can usually be erased from a different angle of view. FIG. 6 demonstrates such a situation where one neuron obstructs another in the rendering result. The eraser is used to remove the mistakenly-selected structures.

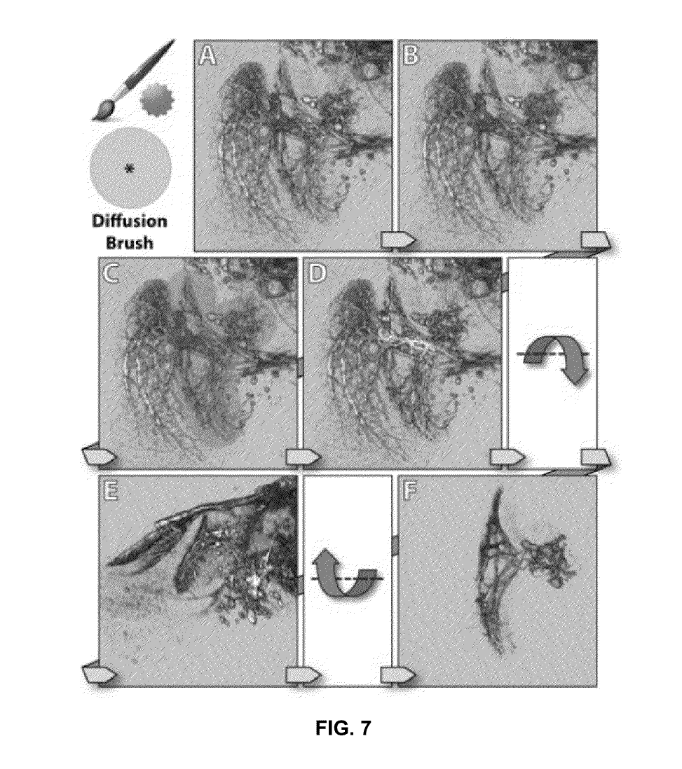

The diffusion brush only defines a diffusion region. It generates no new seeds and only diffuses existing selections within the region defined by its strokes. Thus it has to be used after the selection brush. With the combination of the selection brush and the diffusion brush, occluded or occluding neural structures can be extracted easily, even without changing viewing angles. FIG. 7 shows the same example as in FIG. 6. First, the selection brush is used to extract only the non-obstructing part of the neuron. Then the remaining of the neuron is appended to the selection by painting with the diffusion brush. Since the obstructing part is not connected to the neuron behind, and the diffusion brush does not generate new seeds in that region, the neuron behind is not selected.

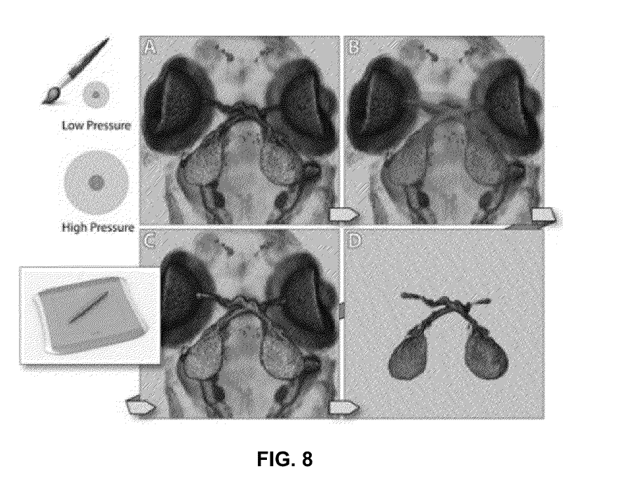

As seen in the above examples, the interactive segmentation scheme disclosed herein allows inaccurate user inputs within fairly good tolerance. However, using a mouse to conduct painting work is not only imprecise but also causes fatigue. Accordingly, in various embodiments the disclosed methods can be performed using a digital tablet to improve user dexterity. In these embodiments, the active tablet area is automatically mapped to the render viewport. Thus, all the available area on the tablet is used in order to maximize the precision, and the user can better estimate the location of the strokes even when the stylus is hovering above the active area of the tablet. Furthermore, stylus pressure can be utilized to control the brush size, a feature that can be turned off by users. The brush size can be varied during a stroke and therefore can help extract structures (e.g. neural structures) of varying sizes with greater precision (FIG. 8).

The interactive volume segmentation functions have been integrated into a confocal visualization tool, FluoRender [31]. The calculations for morphological diffusion use FluoRender's rendering pipelines, which are implemented with OpenGL and GLSL. In various embodiments, painting interactions may be facilitated by keyboard shortcuts, which make most operations fluid.

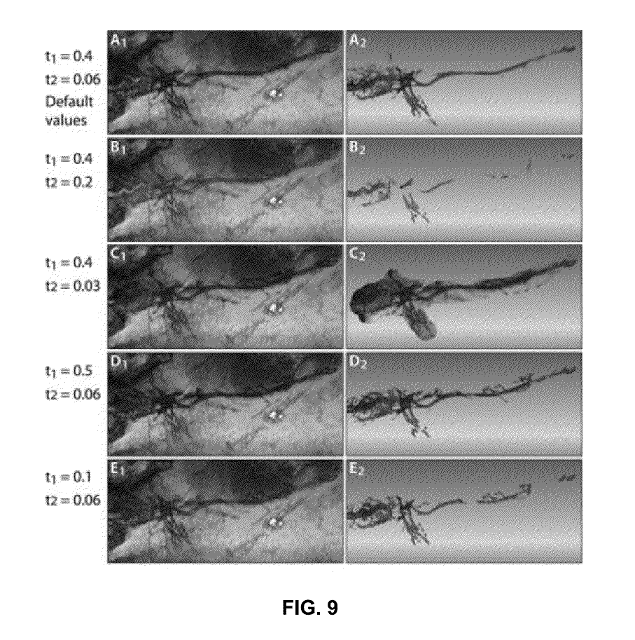

As discussed above, the stopping function of morphological diffusion has four adjustable parameters, namely shift (t₁, t₂) and steepness (k₁, k₂) values for scalar and gradient magnitude falloffs (see FIG. 4), which, in various embodiments, can be set by the user in order to have control over identification of structures. However, in order to reduce the total number of user-adjustable parameters, the steepness values (k₁ and k₂ in Equation 9) may in some embodiments be empirically determined and fixed to 0.02, which can generate satisfactory structural boundary definitions for most types of data. FIG. 9 compares the results when these parameters are adjusted, as well as results of the default values that have been determined empirically. The default values can usually connect faintly stained fibers while preventing noise data from being selected. Since the disclosed segmentation method is implemented in real-time in many embodiments, users can tweak the parameters between strokes and adjust for over- and under-segmentation mistakes.

An additional parameter that can be adjusted is the number of iteration times for morphological diffusion. Typically, whether convergence is reached is tested after each iteration; however, performing this test slows down the calculation and interferes with real-time performance. Therefore, in various embodiments the iteration time is set to an empirically-derived value, which in one particular embodiment is 30 iterations. As discussed above, morphological diffusion typically requires fewer iterations to reach a stable state. Thus, the empirically-determined value ensures both satisfactory segmentation results and interactive speed.

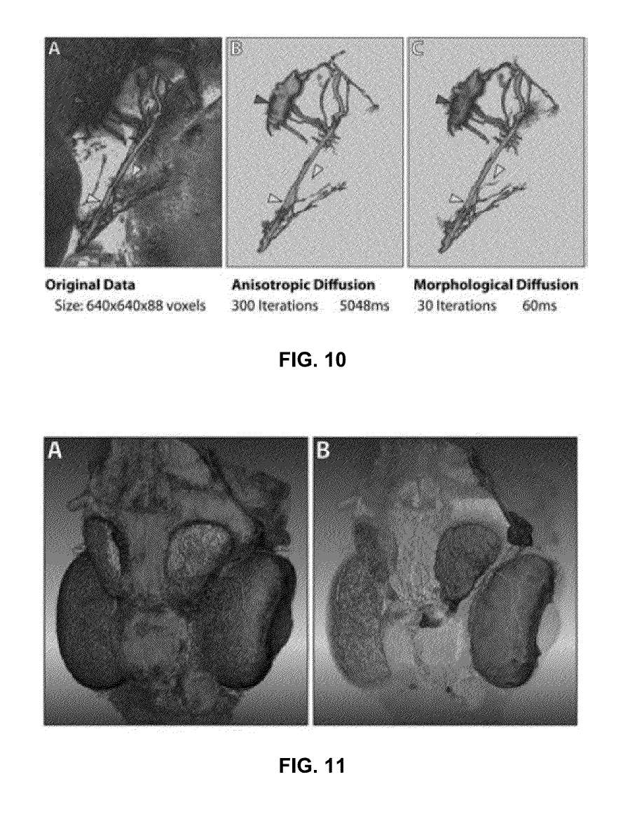

To demonstrate the computational efficiency of the disclosed segmentation algorithm, the same user interactions are used with two different methods for region growing: standard anisotropic diffusion as in [24] and the methods disclosed herein, which are based on morphological diffusion. The comparisons are shown in FIG. 10. The iteration numbers of the two methods are determined to ensure that the diffusion processes converge. The method disclosed herein uses both fewer iterations and less computation time to converge compared to the method based on anisotropic diffusion. Accordingly, the disclosed methods can be carried out to implement interactive volume painting selection with negligible latency. In addition, certain features such as fine details of the confocal data shown in FIG. 10 are also better extracted using the disclosed methods, which make the result more appealing to neurobiologist users.

Nevertheless, it should be noted that the disclosed methods are particularly suited to the type of data on which FIG. 10 is based, since these methods are based on the assumption that high scalar values are always preferred over lower ones in the volume. For dense volume data with multiple layers of different scalar intensities, the disclosed methods in some instances have the limitation that it may not correctly extract desired structures. One possible extension of the disclosed method would be to combine it with transfer function designs, which can be used to generate re-ordered scalar intensities depending on importance for structure extraction.

With the easy-to-use segmentation functions available with FluoRender, neurobiologist users can select and separate structures with different colors when visualizing data. Thus the disclosed methods can be used for interactive data exploration in addition to transfer function adjustments. FIG. 11 shows a result generated with the disclosed interactive segmentation method. The zebrafish head dataset has one channel of stained neurons and one of nuclei. The tectum (magenta), the eye motor neuron (red) and the eye (green) are extracted and colored differently, which make their spatial relationships better perceived. The nucleus channel is layered behind the extracted structures and used as a reference for their positions in the head.

Disclosed herein are interactive techniques for extracting neural structures from confocal volumes. We first derived morphological diffusion from anisotropic diffusion and morphological gradient, and then we used the result to design user interactions for painting and region growing. Since the user interactions work directly on rendering results and are real-time, combined visualization and segmentation are achieved. Using this combination it is now easy and intuitive to extract complex neural structures from confocal data, which are usually difficult to select with 2D-slice-based user interactions.

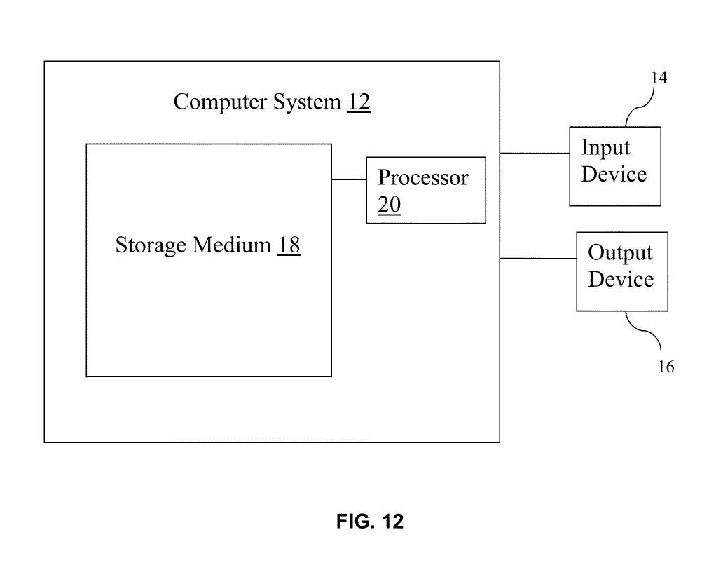

In various embodiments, the disclosed methods may be implemented on one or more computer systems 12 (FIG. 12). Each computer system 12 may be in wired or wireless communication with one another through a combination of local and global networks including the Internet. Each computer system 12 may include one or more input device 14, output device 16, storage medium 18, and processor 20. Possible input devices include a keyboard, a computer mouse, a touch pad, a touch screen, a digital tablet, a microphone, a track ball, and the like. Output devices include a cathode-ray tube (CRT) computer monitor, a liquid-crystal display (LCD) or LED computer monitor, touch screen, speaker, and the like. Storage media include various types of local or remote memory devices such as a hard disk, RAM, flash memory, and other magnetic, optical, physical, or electronic memory devices. The processor may be any typical computer processor for performing calculations and directing other functions for performing input, output, calculation, and display of data in accordance with the disclosed methods. In various embodiments, implementation of the disclosed methods includes generating sets of instructions and data (e.g. including image data and numerical data) that are stored on one or more of the storage media and operated on by a controller.

In some embodiments, implementation of the disclosed methods may include generating one or more web pages for facilitating input, output, control, analysis, and other functions. In other embodiments, the methods may be implemented as a locally-controlled program on a local computer system which may or may not be accessible to other computer systems. In still other embodiments, implementation of the methods may include generating and/or operating modules which provide access to portable devices such as laptops, tablet computers, digitizers, digital tablets, smart phones, and other devices.

### REFERENCES

Each of the following references is incorporated herein by reference in its entirety:

[1] S. Abeysinghe and T. Ju. Interactive skeletonization of intensity volumes. The Visual Computer, 25(5):627-635, 2009.

[2] D. Akers. Cinch: a cooperatively designed marking interface for 3d pathway selection. In Proceedings of the 19th annual ACM symposium on User interface software and technology, pages 33-42, 2006.

[3] K. Bürger, J. Krüger, and R. Westermann. Direct volume editing. IEEE Transactions on Visualization and Computer Graphics, 14(6):1388-1395, 2008.

[4] J. R. Cannon. The One-Dimensional Heat Equation. Addison-Wesley and Cambridge University Press, first edition, 1984.

[5] H.-L. J. Chen, F. F. Samavati, and M. C. Sousa. Gpu-based point radiation for interactive volume sculpting and segmentation. The Visual Computer, 24(7):689-698, 2008.

[6] R. C. Gonzalez and R. E. Woods. Digital Image Processing. Prentice Hall, third edition, 2008.

[7] Z. Hosssain and T. Möller. Edge aware anisotropic diffusion for 3d scalar data. IEEE Transactions on Visualization and Computer Graphics, 16(6):1376-1385, 2010.

[8] W.-K. Jeong, J. Beyer, M. Hadwiger, A. Vazquez, H. Pfister, and R. T. Whitaker. Scalable and interactive segmentation and visualization of neural processes in em datasets. IEEE Transactions on Visualization and Computer Graphics, 15(6):1505-1514, 2009.

[9] J. Kniss and G. Wang. Supervised manifold distance segmentation. IEEE Transactions on Visualization and Computer Graphics, 17(11):1637-1649, 2011.

[10] K. Kutulakos and S. Seitz. A theory of shape by space carving. In Computer Vision, 1999. The Proceedings of the Seventh IEEE International Conference on, volume 1, pages 307-314, 1999.

[11] A. E. Lefohn, J. M. Kniss, C. D. Hansen, and R. T. Whitaker. Interactive deformation and visualization of level set surfaces using graphics hardware. In Proceedings of the 14th IEEE Visualization 2003 (VIS'03), pages 75-82, 2003.

[12] J. Liu, J. Sun, and H.-Y. Shum. Paint selection. ACM Transactions on Graphics, 28(3):69:1-69:7, 2009.

[13] W. N. Martin and J. K. Aggarwal. Volumetric descriptions of objects from multiple views. IEEE Transactions on Pattern Analysis and Machine Intelligence, 5(2):150-158, 1983.

[14] D. R. Olsen, Jr. and M. K. Harris. Edge-respecting brushes. In Proceedings of the 21st annual ACM symposium on User interface software and technology, pages 171-180,2008.

[15] S. Osher and J. A. Sethian. Fronts propagating with curvature-dependent speed: algorithms based on hamilton-jacobi formulations. Journal of Computational Physics, 79(1):12-49,1988.

[16] H. Otsuna and K. Ito. Systematic analysis of the visual projection neurons of drosophila melanogaster. i. lobula-specific pathways. The journal of comparative neurology, 497(6):928-958, 2006.

[17] S. Owada, F. Nielsen, and T. Igarashi. Volume catcher. In Proceedings of the 2005 symposium on Interactive 3D graphics and games, pages 111-116,2005.

[18] S. Owada, F. Nielsen, T. Igarashi, R. Haraguchi, and K. Nakazawa. Projection plane processing for sketch-based volume segmentation. In Proceedings of the 5th IEEE International Symposium on Biomedical Imaging: From Nano to Macro, pages 117-120, may 2008.

[19] P. Perona and J. Malik. Scale-space and edge detection using anisotropic diffusion. IEEE Transactions on Pattern Analysis and Machine Intelligence, 12(7):629-639, 1990.

[20] J.-F. Rivest, P. Soille, and S. Beucher. Morphological gradients. Journal of Electronic Imaging, 2(4):326-341, 1993.

[21] A. Saad, G. Hamarneh, and T.Moller. Exploration and visualization of segmentation uncertainty using shape and appearance prior information. IEEE Transactions on Visualization and Computer Graphics, 16(6):1366-1375, 2010.

[22] A. Saad, T. M^{\ddot{}} oller, and G. Hamarneh. Probexplorer: Uncertainty-guided exploration and editing of probabilistic medical image segmentation. Computer Graphics Forum, 29(3):1113-1122, 2010.

[23] C. Segall and S. Acton. Morphological anisotropic diffusion. In Proceedings of International Conference on Image Processing 1997, volume 3, pages 348-351, Oct 1997.

[24] A. Sherbondy, M. Houston, and S. Napel. Fast volume segmentation with simultaneous visualization using programmable graphics hardware. In Proceedings of the 14th IEEE Visualization 2003 (VIS'03), pages 171-176, 2003.

[25] P. Soille. Morphological Image Analysis: Principles and Applications. Springer-Verlag, second edition, 2002.

[26] R. Sowell, L. Liu, T. Ju, C. Grimm, C. Abraham, G. Gokhroo, and D. Low. Volume viewer: an interactive tool for fitting surfaces to volume data. In Proceedings of the 6th Eurographics Symposium on Sketch-Based Interfaces and Modeling, pages 141-148, 2009.

[27] T. L. Tay, 0. Ronneberger, S. Ryu, R. Nitschke, and W. Driever. Comprehensive catecholaminergic projectome analysis reveals single-neuron integration of zebrafish ascending and descending dopaminergic systems. Nature Communications, 2:171, 2011.

[28] L. Vincent and P. Soille. Watersheds in digital spaces: an efficient algorithm based on immersion simulations. IEEE Transactions on Pattern Analysis and Machine Intelligence, 13(6):583-598, 1991.

[29] I. Viola, A. Kanitsar, and M. E. Grolier. Hardware-based nonlinear filtering and segmentation using high-level shading languages. In Proceedings of the 14th IEEE Visualization 2003 (VIS'03), pages 309-316, 2003.

[30] Visage Imaging. Amira, 2011. http://www.amiravis.com.

[31] Y. Wan, H. Otsuna, C.-B. Chien, and C. Hansen. An interactive visualization tool for multi-channel confocal microscopy data in neurobiology research. IEEE Transactions on Visualization and Computer Graphics, 15(6):1489-1496, 2009.

[32] X. Yuan, N. Zhang, M. X. Nguyen, and B. Chen. Volume cutout. The Visual Computer, 21(8):745-754, 2005.

Thus, the invention provides, among other things, a method of identifying a structure in a volume of data, a computer-based system for identifying a structure in a volume of data, and a computer-readable medium. Various features and advantages of the invention are set forth in the following claims.

What is claimed is:

1. A method of identifying a structure in a volume of data, comprising:
generating a scalar mask volume which corresponds to at least a portion of the volume of data;
displaying the volume of data to a user through a viewport;
obtaining from a user at least one seed region identified on the viewport;
projecting the seed region from the viewport into the scalar mask volume to identify at least one segmentation seed within the scalar mask volume;
obtaining from a user at least one diffusion region identified on the viewport;
projecting the diffusion region from the viewport into the scalar mask volume to identify a region for seed growth within the scalar mask volume; and
growing the at least one segmentation seed within the scalar mask volume to identify a structure within the volume of data.

2. The method of claim 1, wherein growing the at least one segmentation seed comprises growing the at least one segmentation seed using morphological diffusion.

3. The method of claim 1, wherein growing the at least one segmentation seed comprises expanding the at least one segmentation seed until a stop limit is determined.

4. The method of claim 3, wherein a stop limit is determined by evaluating the volume of data to identify at least one of a gradient magnitude and a scalar value.

5. The method of claim 1, wherein seed growth continues until a boundary of the region for seed growth is reached.

6. The method of claim 1, wherein seed growth continues until a stop limit is identified or a boundary of the region for seed growth is reached.

7. The method of claim 1, wherein projecting the seed region into the scalar mask volume comprises projecting each pixel of the seed region from the viewport into voxels of the scalar mask volume, generating a union of the voxels into which the viewport pixels are projected, and thresholding the voxels in the union to identify at least one seed.

8. The method of claim 1, wherein the viewport comprises a perspective projection and wherein projecting the seed region from the viewport comprises generating a conical projection from each pixel of the seed region from the viewport into the scalar mask volume.

9. The method of claim 1, wherein the viewport comprises an orthographic projection and wherein projecting the seed region from the viewport comprises generating a cylindrical projection from each pixel of the seed region from the viewport into the scalar mask volume.

10. The method of claim 1, wherein obtaining from a user comprises obtaining from a user using a simulated paintbrush tool.

11. The method of claim 10, wherein the user simultaneously identifies the seed region and the diffusion region using the simulated paintbrush tool.

12. The method of claim 1, further comprising erasing at least a portion of the seed region or the diffusion region using an eraser tool.

13. The method of claim 1, wherein the structure within the volume of data corresponds to a neural structure.

14. A computer-based system for identifying a structure in a volume of data, the system comprising:
a processor; and
a storage medium operably coupled to the processor, wherein the storage medium includes,
program instructions executable by the processor for
generating a scalar mask volume which corresponds to at least a portion of the volume of data;
displaying the volume of data to a user through a viewport;
obtaining from a user at least one seed region identified on the viewport;
projecting the seed region from the viewport into the scalar mask volume to identify at least one segmentation seed within the scalar mask volume;
obtaining from a user at least one diffusion region identified on the viewport;
projecting the diffusion region from the viewport into the scalar mask volume to identify a region for seed growth within the scalar mask volume; and
growing the at least one segmentation seed within the scalar mask volume to identify a structure within the volume of data.

15. The computer-based system of claim 14, further comprising a digital tablet, and wherein at least one of obtaining from a user at least one seed region identified on the viewport and obtaining from a user at least one diffusion region identified on the viewport further comprises obtaining from a user at least one seed region identified on the viewport using the digital tablet

16. The computer-based system of claim 15, wherein the digital tablet controls a simulated paintbrush tool and wherein an area of the simulated paintbrush tool is determined by a pressure applied to the digital tablet.

17. The computer-based system of claim 14, further comprising a touch screen display, and wherein at least one of displaying the volume of data to a user through a viewport, obtaining from a user at least one seed region identified on the viewport, and obtaining from a user at least one diffusion region identified on the viewport are performed using the touch screen display.

18. The computer-based system of claim 14, further comprising a pointer device and wherein at least one of obtaining from a user at least one seed region identified on the viewport and obtaining from a user at least one diffusion region identified on the viewport are performed using the pointer device.

19. The computer-based system of claim 18, wherein the pointer device is selected from a mouse, a touch pad, and a track ball.

20. A computer-readable medium, comprising:
first instructions executable on a computational device for generating a scalar mask volume which corresponds to at least a portion of the volume of data;
second instructions executable on the computational device for displaying the volume of data to a user through a viewport;
third instructions executable on the computational device for obtaining from a user at least one seed region identified on the viewport;
fourth instructions executable on the computational device for projecting the seed region from the viewport into the scalar mask volume to identify at least one segmentation seed within the scalar mask volume;
fifth instructions executable on the computational device for obtaining from a user at least one diffusion region identified on the viewport;
sixth instructions executable on the computational device for projecting the diffusion region from the viewport into the scalar mask volume to identify a region for seed growth within the scalar mask volume; and
seventh instructions executable on the computational device for growing the at least one segmentation seed within the scalar mask volume to identify a structure within the volume of data.
